(19) United States
(12) Patent Application Publication
(10) Pub. No.: US 2026/0195936 A1
(43) Pub. Date: Jul. 9, 2026

(54) TRAILER BACKUP TRAJECTORY OVERLAY USING TRAILER CAMERA DISPLAY SYSTEM

(71) Applicant: STONERIDGE, INC., Novi, MI (US)

(72) Inventors: Liang Ma, Rochester, MI (US); Wenpeng Wei, East Lansing, MI (US); Troy Otis Cooprider, White Lake, MI (US); Utkarsh Sharma

(21) Appl. No.: 19/127,870

(22) PCT Filed: Nov. 14, 2023
(86) PCT No.: PCT/US2023/079589

§ 371 Date: May 7, 2025

Related U.S. Application Data
(60) Provisional application No. 63/426,391, filed on Nov. 18, 2022.

(51) Int. Cl. G06T 11/10; B60R 1/25; B60R 1/26; B62D 15/02; G06T 7/277; G06T 7/70; G06V 20/58; H04N 7/18; H04N 23/90

(52) U.S. Cl. CPC G06T 11/10; B60R 1/25; B60R 1/26; G06T 7/277; G06T 7/70; G06V 20/58; H04N 7/181; H04N 23/90; B60R 2300/105; B60R 2300/308; B60R 2300/8046; B60R 2300/8086; B62D 15/0295; G06T 2207/10016; G06T 2207/30241; G06T 2207/30261

(57) ABSTRACT

A controller is connected to multiple cameras on a vehicle. At least one side camera is configured to define a rear side view and at least one rear camera that is configured to generate a rear facing view. Memory storing instructions cause the processor to determine a trailer angle of a trailer, relative to a tractor, based on images that are provided by the at least one side camera, causing the processor to estimate a trailer angle rate, causing the processor to determine a trailer end location at multiple instances based at least in part on a vehicle speed, the estimated trailer angle rate, and the determined trailer angle. A projected trailer path is determined using the determined trailer end locations, and an overlay is generated on a display that depicts the projected trailer path.

### CROSS-REFERENCE TO RELATED APPLICATION

This application claims priority to Untied States Provisional Application No. 63/426,391 filed Nov. 18, 2022.

### TECHNICAL FIELD

This disclosure relates to a camera monitoring system (CMS) for use in a vehicle pulling a trailer, and in particular to a system for displaying a projection of an expected trailer path during a reversing maneuver.

### BACKGROUND

Mirror replacement systems, and camera systems for supplementing mirror views, are utilized in commercial vehicles to enhance the ability of a vehicle operator to see a surrounding environment. Camera monitoring systems (CMS) utilize one or more cameras disposed about the vehicle to provide an enhanced field of view to a vehicle operator. In some examples, mirror replacement systems within the CMS can cover a larger field of view than a conventional mirror, or can include views that are not fully obtainable via a conventional mirror.

The area behind a trailer is a typical blind spot in a conventional mirror system resulting in difficult reversing maneuvers while a trailer is attached. Further impacting the difficulty for vehicle operation is the fact that the trailer motion during a reversing maneuver is different from trailer motion during a forward maneuver and driver assistance systems and estimation techniques that are usable for forward maneuvers are not typically usable during reversing maneuvers.

### SUMMARY

In one exemplary embodiment, a camera monitoring system (CMS) for a vehicle includes a CMS controller that includes a memory and a processor. The CMS controller is connected to multiple cameras that are disposed about a vehicle and configured to receive a video feed from each of the cameras in the cameras. The CMS controller includes at least one side camera that is configured to define a rear side view and at least one rear camera that is configured to generate a rear facing view. Memory storing instructions cause the processor to determine a trailer angle of a trailer, relative to a tractor, based on images that are provided by the at least one side camera, causing the processor to estimate a trailer angle rate, causing the processor to determine a trailer end location at multiple instances based at least in part on a vehicle speed, the estimated trailer angle rate, and the determined trailer angle. A projected trailer path is determined using the determined trailer end locations and causes the processor to generate an overlay that depicts the projected trailer path and apply the overlay to a rear view display.

In a further embodiment of any of the above, determining the trailer end location at the instances includes one of determining the trailer end location at multiple time intervals and determining the trailer end location at multiple distance intervals.

In a further embodiment of any of the above, the rear facing view includes at least one of a class VIII view and a rear view mirror replacement view.

In a further embodiment of any of the above, the rear facing view includes at least a portion of the trailer.

In a further embodiment of any of the above, the processor is configured to estimate a trailer angle rate using Kalman filtering.

In a further embodiment of any of the above, determining a projected trailer path using the determined trailer end locations includes computing a 3D trajectory using a least square fitting to compute a trailer trajectory in 3D space and converting the 3D trajectory.

In a further embodiment of any of the above, generating an overlay depicting the projected trailer path includes converting the 3D trajectory to a 2D image.

In a further embodiment of any of the above, determining a trailer angle of a trailer, relative to a tractor, based on images that are provided by the at least one side camera includes determining the trailer angle without using a dedicated angle detection sensor.

In a further embodiment of any of the above, the memory further stores instructions that are configured to cause the processor to identify at least one object within a rear view image that includes the rear side view and the rear facing view, and configured to alter the overlay in response to the at least one object that intersects with the overlay in the rear view image.

In a further embodiment of any of the above, the overlay is altered by changing the color of the overlay.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitoring system (CMS) used to provide at least Class II and Class IV views.

FIG. 1B is a schematic top elevational view of a commercial truck with a camera mirror system providing Class II, Class IV, Class V, Class VI and Class VIII views.

FIG. 2 is a schematic illustration of an interior of a vehicle cab.

FIG. 3 schematically illustrates a rear view replacement display scene including a projected trailer trajectory.

FIG. 4 illustrates a method for creating a rear view trajectory overlay for the rear view replacement display scene of FIG. 3.

FIG. 5 illustrates a method for generating an alert based on the projected trajectory.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

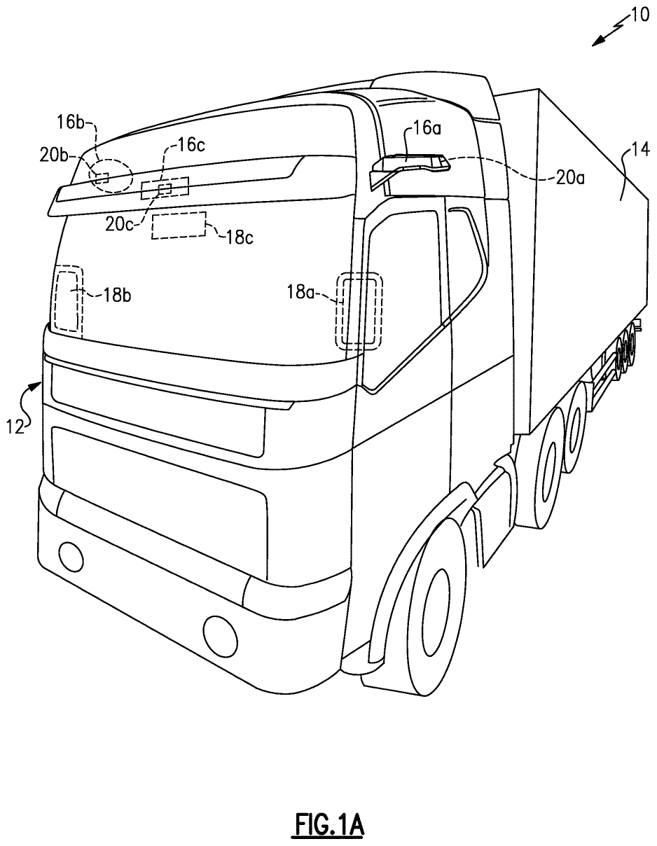

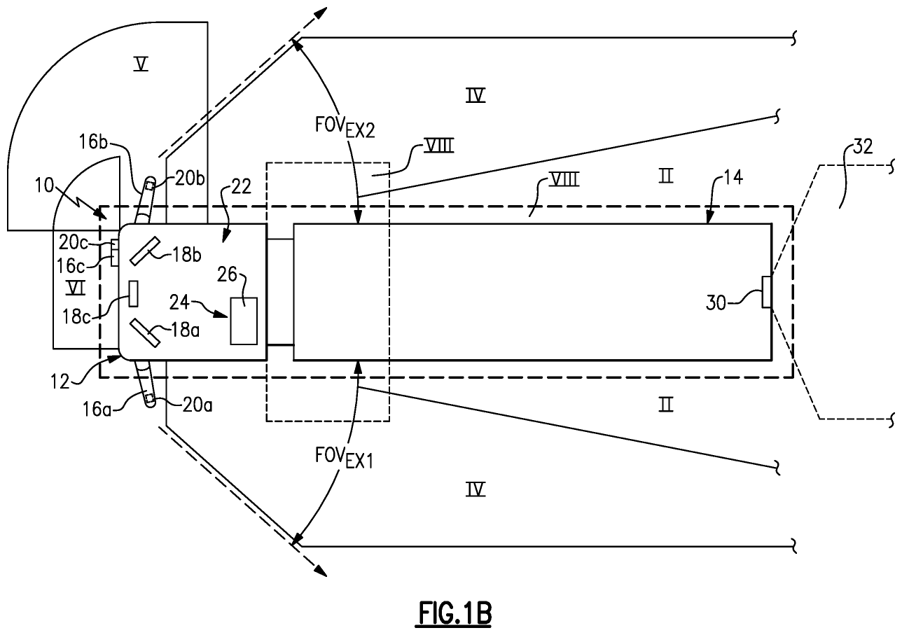

A schematic view of a commercial vehicle 10 is illustrated in FIGS. 1A and 1B. FIG. 2 is a schematic top perspective view of the vehicle 10 cabin including displays and interior cameras. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 2) that has driver and passenger side camera arms 16a, 16b (generally, “16”)mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b (generally, “20”) is arranged respectively within camera arms. The exterior cameras 20a, 20b respectively provide an exterior field of view FOV_{EX1}, FOV_{EX2} that each include at least one of the Class II and Class IV views (FIG. 1B), which are legal prescribed views in the commercial trucking industry. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. Each arm 16a, 16b may also provide a housing that encloses electronics that are configured to provide various features of the CMS 15.

First and second video displays 18a, 18b (generally, “18”) are arranged on each of the driver and passenger sides within the vehicle cab 12 on or near the A-pillars 19a, 19b to display Class II and Class IV views on its respective side of the vehicle 10, which provide rear facing side views along the vehicle 10 that are captured by the exterior cameras 20a, 20b.

If video of Class V and/or Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver. The displays 18a, 18b, 18c face a driver region 24 within the cabin 22 where an operator is seated on a driver seat 26. The location, size and field(s) of view streamed to any particular display may vary from the configurations described in this disclosure and still incorporate the disclosed invention.

If video of Class VIII views is desired, camera housings can be disposed at the sides and rear of the vehicle 10 to provide fields of view including some or all of the Class VIII zones of the vehicle 10. As illustrated, the Class VIII view includes views immediately surrounding the trailer, and in the rear proximity of the vehicle including the rear of the trailer. In one example, a view of the rear proximity of the vehicle is generated by a rear facing camera disposed at the rear of the vehicle, and can include both the immediate rear proximity and a traditional rear view (e.g. a view extending rearward to the horizon, as may be generated by a rear view mirror in vehicles without a trailer). In such examples, the third display 18c can include one or more frames displaying the Class VIII views. Alternatively, additional displays can be added near the first, second and third displays 18a, 18b, 18c and provide a display dedicated to providing a Class VIII view.

In some cases, the Class VIII view is generated using a trailer mounted camera 30. The trailer mounted camera 30 is a rear facing camera which provides a field of view 32 that encompasses a portion of the trailer, the rear facing Class VIII view and a conventional rear view mirror. This rear view mirror portion can be identified by the CMS 15 and provided to one of the displays 18a, 18b and/or another display 18c within the vehicle cabin 22 as a rear view mirror replacement or as a rear view mirror supplement. This view is particularly beneficial as the trailer 14 may block some, or all, views provided by a conventional rear view mirror.

The CMS 15 is also configured to utilize the images from the cameras 20a, 20b, 30 as well as images from other cameras that may be disposed about the vehicle to determine features of the vehicle, identify objects, and facilitate driver assistance features such as display overlays and semi-automated driver assistance systems.

These features and functions of the CMS 15 are used to implement multiple CMS 15 systems that aid in operation of the vehicle. It should be noted that a controller 28 (FIG. 2) for the CMS 15 can be used to implement the various functionalities disclosed in this application. The controller 28, which is in communication with the displays 18 and cameras 20, may include one or more discrete units. For example, a centralized architecture may have a common controller arranged in the vehicle 10, while a decentralized architecture may use a controller provided in each of the displays 18, for example. Moreover, a portion of the controller 28 may be provided in the vehicle 10, while another portion of the controller 28 may be located elsewhere, for example, the camera arms 16. In another example, a master-slave display configuration may be used where one display includes the controller 28 while the other display receives the commands from the controller 28.

In terms of hardware architecture, such a controller can include a processor, memory (e.g., memory), and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 28 may be a hardware device for executing software, particularly software stored in memory (e.g., memory). The controller 28 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 28 is in operation, the processor can be configured to execute software stored within the memory, to communicate data to and from the memory and to generally control operations of the computing device pursuant to the software. Software in memory, in whole or in part, is read by the processor, perhaps buffered within the processor, and then executed.

In various examples, the controller 28 includes one or modules having algorithm(s), equation(s) and/or decision manager(s) that receive input(s) from sensors and/or stored values. During vehicle operation, the controller 28 may communicate information to the driver, fleet operator, or others using an output (e.g. displays 18, speaker, etc.).

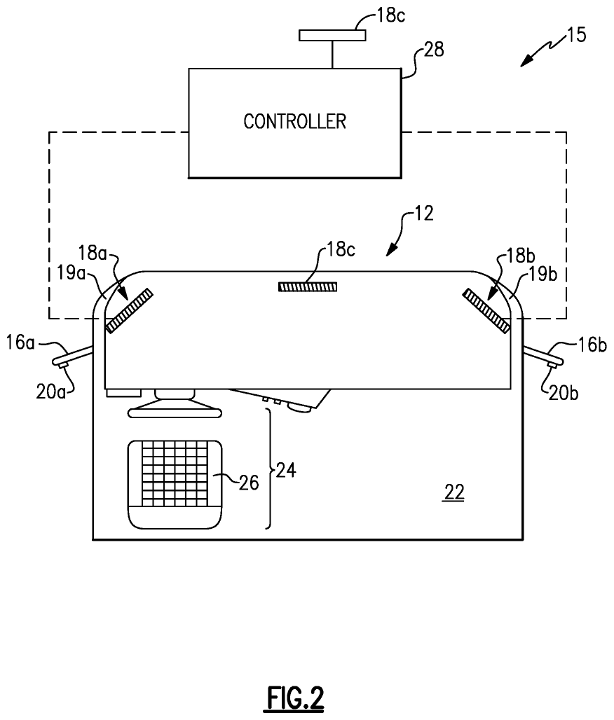

One such CMS system is a reversing assist system that generates a trailer trajectory projection for a reversing maneuver of a vehicle 10. An example output of the reversing assist system is illustrated in the rear view replacement scene 100 of FIG. 3. While the illustrated replacement scene 100 includes a single person 120 and a single tree 130 for ease of description, it is appreciated that the replacement scene 100 could, in a practical example, include more objects, more varied objects, a road, multiple classes of objects, etc. In the illustrated example, the scene 100 includes at least a portion of the rear end of the trailer 14. The scene 100 is displayed on one or more of the monitors 18a, 18b, 18c and/or another monitor within the vehicle.

During a reversing maneuver, the CMS 15 uses the reversing assist system to determine a projected rear trajectory (i.e., the expected path of a rear end of the trailer 14) and provides the projected trajectory as an overlay 110 on top of the scene 100. The overlay 110 extends from the rear end of the trailer 14 into the scene 100 and tracks the expected position of the rear end of the trailer 14 over time and/or distance. When the predicted trajectory intersects with an object (e.g., person 120) the CMS 15 can generate an alert that indicates a potential collision may occur. The alert takes the form of an audio output to the operator, a shaded identifier 122 in the overlay 110, a color change, or any combination thereof. In other examples, any other method of directing the operator's attention to the object 120 can be utilized.

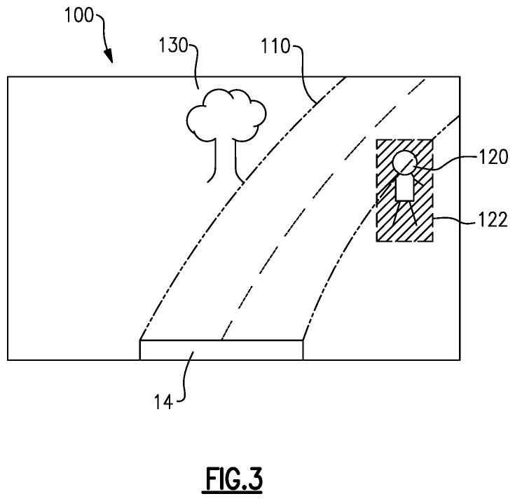

With continued reference to the scene 100 of FIG. 3, FIG. 4 schematically illustrates a process 300 for generating the overlay 110. Initially, the CMS 15 receives images from the rear facing camera(s) 30, from the Class II/IV cameras, and the other cameras in the CMS 15. The CMS 15 then uses image analysis techniques to determine a trailer 14 end position in a three dimensional (real world) space and a trailer angle relative to the tractor 12 in a “Determine Trailer End Position and Angle” step 310. In one example, the trailer angle and end position are determined exclusively using image analysis without the use of angle sensors or other sensors beyond the image sensors (cameras) of the CMS 15. In addition, during this step the CMS 15 receives multiple parameters from the vehicle controller including truck speed, yaw rate, steering angle, gear and other camera extrinsic parameters.

As the vehicle 10 operates, the trailer end position and angle are calculated from the image multiple times, and a rate of change of the trailer angle and trailer position is determined in an “Estimate Trailer Angle Change Rate” step 320. The rat of change can be over time, over distance, or a combination of the two. In one example, the rate of change is determined by applying a Kalman filter to the determined trailer end positions and trailer angles, as well as the additional parameters received from a vehicle controller with output of the Kalman filter being the rate of change. The rate of change tracks the change in position of the trailer end in 3D space and is redetermined in each iteration of the process 300. In one example, the trailer angle rate and truck speed are converted to trailer end's motion in two perpendicular (x and y) directions. An integration formula computes the trailer end's location change over a period (E.G., 1 second, 2 seconds, etc.). With the prediction of trailer end location over the computed periods, the trajectory is obtained by connecting the dots.

Once the rate of change of the trailer end has been determined, the CMS 15 computes what the estimated position of the trailer end will be in three dimensional space at a given time and/or distance interval in a “Computer Trailer End location” step 330. The process 300 loops the step 330 multiple times, with each loop determining the estimated end position at a distinct time and/or distance interval. The time and/or distance intervals are, in some examples, fixed intervals stored in a memory of the CMS 15. In alternative examples, the time and/or instant intervals can be dependent on speed, yaw rate, or any other parameter.

After determining the trailer end position at each of the intervals, the process 300 combines the trailer end positions to create a projected trajectory of the trailer end in a “Determine Trailer Trajectory in 3D space” step 340. The trailer trajectory is the route that the trailer end is expected to travel through in three dimensional space as the trailer end travels from each determined interval to the next determined interval.

In one example, the complete trajectory connecting the trailer end positions at each determined interval is determined using least square filtering the trailer end points at each interval and the resultant curve is the predicted trajectory.

After determining the 3D trajectory of the trailer end, the 3D trajectory is converted into a two dimensional graphical overlay in a “Convert 3D Trajectory to 2D Overlay” step 350. The conversion converts the three dimensional trailer end route to a two dimensional track through the scene 100 and creates a transparent overlay 110 of the track.

Once the transparent overlay 110 has been created, the overlay 110 is applied to the image and displayed to the operator in a “Apply 2D Overlay to Rear View Display” step 360.

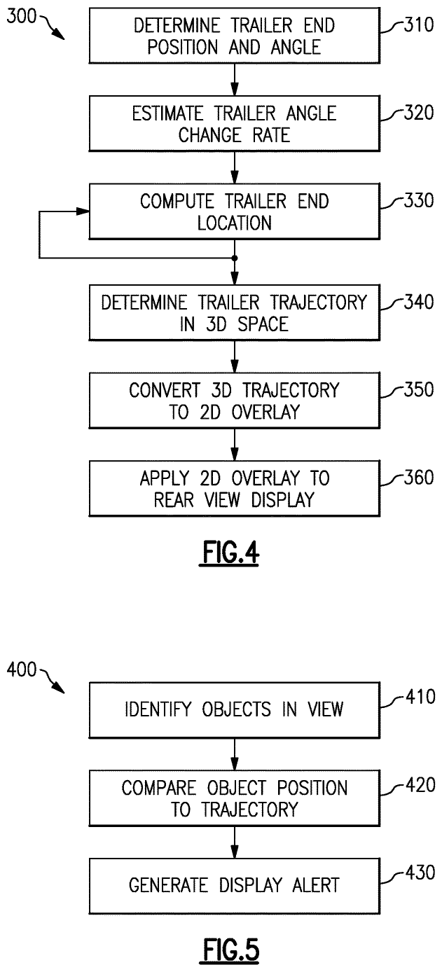

In some examples, after determining the trajectory and before applying the overlay to the scene 100, the CMS 15 identifies any objects 120, 130 in the scene 100 that will intersect with the trajectory and output a warning to the vehicle operator. The warning can take the form of an audio output, a visual indicator (as in the example scene 110), a color change, or any similar alert. FIG. 5 illustrates a method 400 for achieving this alert.

Initially the CMS 15 identifies objects 120, 130 within the scene 100 using image based object identification techniques, and identifies the two dimensional position of the object in the scene 100 in an “Identify Objects in View” step 410. The two dimensional position of the objects 120, 130 within the scene 110 are then converted to a three dimensional position of the object 120, 130 in real space. After determining the three dimensional trajectory of the trailer 14 end, the CMS 15 compares the three dimensional position of each object to the trajectory in “Compare Object Position to Trajectory” step 420, and indicates an alert when the end of the trailer 14 passes through the same three dimensional space as the object 120, 130 in a “Generate Display Alert” step 430.

In more complex systems, a trajectory of the moving objects (e.g., person 120) can be estimated using a similar trajectory estimation process, and the projected trajectory of the moving object is compared to the projected trajectory of the end of the trailer 14. In such examples, and an alert is generated when the trajectory of the object interacts with a trajectory of the trailer 14 at the same time or within a predefined time span (E.G., +/−10 seconds).

Although an example embodiment has been disclosed, a worker of ordinary skill in this art would recognize that certain modifications would come within the scope of the claims. For that reason, the following claims should be studied to determine their true scope and content

What is claimed is:

1. A camera monitoring system (CMS) for a vehicle, comprising:
a CMS controller including a memory and a processor;
the CMS controller being connected to multiple cameras disposed about a vehicle and configured to receive a video feed from each of the cameras in the cameras, the CMS controller including at least one side camera configured to define a rear side view and at least one rear camera configured to generate a rear facing view; and
the memory storing instructions for causing the processor to determine a trailer angle of a trailer, relative to a tractor, based on images provided by the at least one side camera, causing the processor to estimate a trailer angle rate, causing the processor to determine a trailer end location at multiple instances based at least in part on a vehicle speed, the estimated trailer angle rate, and the determined trailer angle, determining a projected trailer path using the determined trailer end locations and causing the processor to generate an overlay depicting the projected trailer path and apply the overlay to a rear view display.

2. The CMS of claim 1, wherein determining the trailer end location at the instances comprises one of determining the trailer end location at multiple time intervals and determining the trailer end location at multiple distance intervals.

3. The CMS of claim 1, wherein the rear facing view includes at least one of a class VIII view and a rear view mirror replacement view.

4. The CMS of claim 3, wherein the rear facing view includes at least a portion of the trailer.

5. The CMS of claim 1, wherein the processor is configured to estimate a trailer angle rate using Kalman filtering.

6. The CMS of claim 1, determining a projected trailer path using the determined trailer end locations comprises computing a 3D trajectory using a least square fitting to compute a trailer trajectory in 3D space and converting the 3D trajectory.

7. The CMS of claim 6, wherein generating an overlay depicting the projected trailer path comprises converting the 3D trajectory to a 2D image.

8. The CMS of claim 1, wherein determining a trailer angle of a trailer, relative to a tractor, based on images provided by the at least one side camera comprises determining the trailer angle without using a dedicated angle detection sensor.

9. The CMS of claim 1, wherein the memory further stores instructions configured to cause the processor to identify at least one object within a rear view image comprising the rear side view and the rear facing view, and configured to alter the overlay in response to the at least one object intersecting with the overlay in the rear view image.

10. The CMS of claim 9, wherein the overlay is altered by changing the color of the overlay.
